(19) United States
(12) Patent Application Publication
(10) Pub. No.: US 2025/0305386 A1
(43) Pub. Date: Oct. 2, 2025

(54) MAGNETIC DEVICE FOR CONTROLLING FLUID FLOW IN A WELL

(71) Applicant: PETRÓLEO BRASILEIRO S.A. - PETROBRAS, Rio de Janeiro (BR)

(72) Inventors: MARIO GERMINO FERREIRA DA SILVA, Rio de Janeiro (BR); LEONARDO OSORIO PELISOLI, Rio de Janeiro (BR); ROBERTO MOTTA GOMES, Rio de Janeiro (BR); ANDRE LEIBSOHN MARTINS, Rio de Janeiro (BR)

(73) Assignee: PETRÓLEO BRASILEIRO S.A. - PETROBRAS, Rio de Janeiro (BR)

(21) Appl. No.: 19/089,897

(22) Filed: Mar. 25, 2025

(30) Foreign Application Priority Data
Mar. 26, 2024 (BR) 1020240060288

(51) Int. Cl. E21B 34/06

(52) U.S. Cl. CPC E21B 34/06

(57) ABSTRACT

The present application discloses a magnetic device for controlling fluid flow in a well. The magnetic device comprises: a base magnetic tube, an external magnetic tube, and a pressure drop channel. The pressure drop channel receives a fluid at an inlet with a first diameter and discharges said fluid at an outlet with a second diameter. The base magnetic tube is fitted inside the external magnetic tube, and the pressure drop channel is formed in a fitting region between the base magnetic tube and the external magnetic tube.

### CROSS-REFERENCES TO RELATED APPLICATION

The application claims priority to Brazilian Patent Application No. BR 10 2024 006028 8, filed Mar. 26, 2024, which is incorporated by reference herein in its entirety.

### FIELD

The present application falls within the technical field of devices for reservoir management, associated with controlling production losses. More specifically, the present application relates to magnetic devices for controlling fluid flow in a well.

### BACKGROUND

Flow control devices (ICD—inflow control device) or autonomous control devices (AICD—autonomous inflow control device), aim to improve oil recovery by controlling the gas-oil ratio (GOR—gas-oil ratio) and the water and sediment ratio (BSW—basic sediment and water) entering the production column of a well.

Flow control devices generally act by applying a pressure drop that varies according to the arrival of a fluid that must be controlled, generally undesirable fluids such as gas, water and sediment. It is desirable that the pressure drop increases considerably when these unwanted fluids arrive, so that production along a well is then focused on areas that are producing hydrocarbons.

However, current flow control devices are particularly susceptible to the formation of scale, especially those installed in areas prone to salt precipitation. This leads to the blocking of these devices and, consequently, to the loss of production associated with scale, as well as the need to stop production to carry out chemical removal treatments, which will generate revenue losses due to production stoppage and costs associated with the use of critical resources such as completion rigs and stimulation vessels.

Therefore, there is a need for progress in scale control solutions in flow control devices with reduced impacts on hydrocarbon production.

### STATE OF THE ART

The state of the art includes the disclosure of some documents that contain teachings regarding flow control devices.

The document “Avaliação experimental de dispositivos magnéticos para prevenção de incrustação e proposta de um modelo físico e de uma metodologia de projeto” (Experimental evaluation of magnetic devices for scale prevention and proposal of a physical model and design methodology” (SANTOS, Hugo Francisco Lisboa. Rio Oil & Gas Conference, 19, 2018, Rio de Janeiro) publishes a study that evaluated the possibility of using magnetic devices to prevent scale in wells with potential for calcium carbonate scale. Tests were carried out in onshore wells using magnetic equipment applied to hydrocarbon transportation pipelines.

The document U.S. Ser. No. 11/091,967 discloses a downhole flow control configuration including a housing, a converging-diverging flow path in the housing. The flow path includes a first portion including an inlet, a converging section, and a throat section. The first portion preferably passes through a portion of a fluid having a higher subcooling. The converging-diverging flow path further includes a second portion comprising a divergent section that recovers fluid pressure lost in the converging section and the throat section, and an outlet and an elongated helical flow path connected to the outlet of the converging-diverging flow path such that, the helical flow path producing a pressure drop in a fluid flowing therein during use.

The document U.S. Ser. No. 10/208,575 discloses a flow control device comprising one or more stacked spiral paths such that, the shape of an inlet to one end of a spiral has a taper on one or more sides to gradually increase the velocity of the polymer to eliminate rapid acceleration points as the flow enters the spiral path. The inlet with its taper may be curved to enter the spiral. The spiral may be inserted tangentially or radially or axially.

The document US 20120168181 discloses an adaptable inward flow control device including a first tubular having a plurality of perforations therethrough, a second tubular positioned radially from the first tubular defining an annular space therebetween having at least one port therethrough, and a pressure drop device disposed in the annular space positioned between the plurality of perforations and the at least one port configured to create a pressure drop in response to fluid flow therethrough. Also included is an expandable means disposed radially outward of the first tubular configured to expand while allowing fluid flow therethrough.

Referring to documents U.S. Ser. No. 11/091,967, U.S. Ser. No. 10/208,575 and US 20120168181, it is noted that the respective convergent sections do not extend along the length of the helical section, being limited to an initial inlet and/or outlet region or not teaching a restriction. Furthermore, the helical section is entirely formed in an internal structure. Finally, there is no mention of the incorporation of magnetic material in the structure of the devices.

Therefore, there remain evident deficiencies in the state of the art. The features and advantages of the present application will clearly emerge from the detailed description below and with reference to the attached drawings. These drawings are provided only as preferred and non-limiting embodiments.

### SUMMARY

The present invention discloses a magnetic device for controlling fluid flow in a well, comprising: a base magnetic tube, an external magnetic tube, and a pressure drop channel. The pressure drop channel receives a fluid at an inlet with a first diameter and discharges said fluid at an outlet with a second diameter. The base magnetic tube is fitted inside the external magnetic tube, and the pressure drop channel is formed in a fitting region between the base magnetic tube and the external magnetic tube.

### BRIEF DESCRIPTION OF THE DRAWINGS

The previous brief description, as well as the detailed description below of the preferred embodiments of the invention in question, will be better understood when read together with the attached drawings. It must be understood, however, that the invention in question is not limited only to the precise arrangements and instruments as shown.

FIG. 1 illustrates a magnetic device for controlling fluid flow in a well according to embodiments of the present invention.

FIG. 2 illustrates a base magnetic tube that composes the magnetic device according to embodiments of the present invention.

FIG. 3 illustrates a base magnetic tube that externalizes the magnetic device according to embodiments of the present invention.

FIG. 4 illustrates details of the pressure drop channel according to embodiments of the present invention.

FIG. 5 illustrates an assembly of the device of the present invention according to embodiments of the present invention.

### DETAILED DESCRIPTION

In the following, reference is made in detail to the preferred embodiments of the present invention illustrated in the attached drawings. Whenever possible, the same or similar reference numbers will be used throughout the drawings to refer to the same or similar features. It should be noted that the drawings are in simplified form and are not represented to a precise scale, so slight variations are anticipated.

Specific embodiments of the present disclosure are described below. In an effort to provide a concise description of these embodiments, all features of an actual implementation may not be described in the specification. It should be appreciated that in the development of any actual implementation, as in any engineering or design project, numerous implementation-specific decisions must be made to achieve the specific objectives of the developers, such as compliance with system-related and business constraints, which may vary from one implementation to another. In addition, it should be appreciated that such a development effort may be complex and time-consuming, but would nevertheless be a routine design and manufacturing undertaking for those of ordinary skill having the benefit of this disclosure.

Accordingly, certain details may be omitted from the description that follows with the understanding that the technician skilled on the subject has prior knowledge to fill these gaps. For example, the specific types of used devices or underlying physical principles may be omitted without impairing the description of the present invention.

The present application seeks to transform the primary flow control mechanism of wells, that is, the flow control devices, so that it changes from a condition of promoting scale to a condition of preventing scale.

Prior to the present application, wells were commonly completed with flow control devices (ICDs and AICDs) installed in the production columns to provide a flow control mechanism.

However, control of the production of undesirable fluids (GOR—produced gas flow rate and BSW—produced water flow rate) by flow control devices from the state of the art is achieved by accepting non-mitigable risks such as: i) well blockage in the event of saline scaling; ii) greater than expected reduction in the production potential of the desirable fluid; and iii) lower than expected gains due to the difficulty of valuing by flow simulation.

The present application uses magnetic protection by including magnetic components in the valve construction design, thus avoiding the formation of scaling precipitates inside. Therefore, it can reduce or eliminate the negative impacts of the risks mentioned above.

Therefore, when a well completion project includes the use of flow control devices, the well will be prepared to start production using the present invention to avoid the formation of blockages due to scale due to its magnetic components.

In various embodiments, if the risks of scale mentioned above materialize, no intervention with a probe or stimulation boat will be necessary for the specific purpose of cleaning the magnetic flow control device of the present invention.

It will be appreciated that the technology proposed in this application can be used in all technically viable scenarios. This includes vertical, directional, or horizontal wells; in sandstone or carbonate reservoirs; with or without sand containment; dry or wet completion; in post-salt and, also, in pre-salt. Nevertheless, specific studies should be conducted to optimize decisions in each scenario.

Furthermore, the present application brings a series of advantages with its implementation, as will be discussed below, but not exhaustively. For example, when used with production wells, it is possible to obtain a reduction in the formation of gas and water cones. Thus, an increase in the cost-effectiveness of production in fields equipped with the technology. In another embodiment, for injection wells, the present application makes it possible to obtain an increase in sweep efficiency due to the uniform flow in the injection and thus contributing to an increase in the field recovery factor.

In various embodiments, the arrangement of one or more of the magnetic devices of the present application can be used to perform autonomous stimulation via a Stationary Production Unit—SPU, which reduces safety risks in relation to work carried out with stimulation boats, which shows at least the risk of collision between the boat and SPU, possibly resulting in the rupture of the pumping lines with leakage of chemical products into the environment.

The device of the present application also increases the reliability of the flow control of the well intervals in relation to the control of GOR (produced gas flow rate) and BSW (produced water flow rate). In this way, the present application may contribute to maintaining the production of the well within the operating limits of the SPU and without compromising the oil flow rate. Thus, it ensures compliance with the requirements of IBAMA and ANP regarding the limits of gas flaring and disposal of produced water and without the need to reduce the flow rate of the well for this control to be carried out.

The control of GOR contributes to the reduction of gas flaring, contributes to the reduction of carbon production. The control of BSW contributes to the reduction of the need for reinjection of water into the reservoir and/or disposal of water.

The control of GOR and BSW contributes to reservoir management with an increase in the recovery factor and maintenance of production, which also promotes the maintenance of royalties that are distributed to society.

### Preferred Embodiment

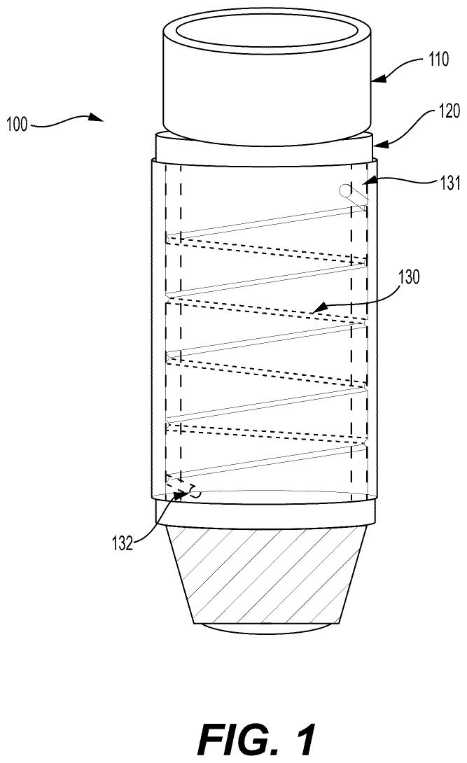

A preferred embodiment of the present application, as illustrated in FIG. 1, discloses a magnetic device 100 for controlling fluid flow in a well comprising at least one of: a base magnetic tube/sleeve 110; an external magnetic tube/sleeve 120; and a pressure drop channel 130, or a combination thereof.

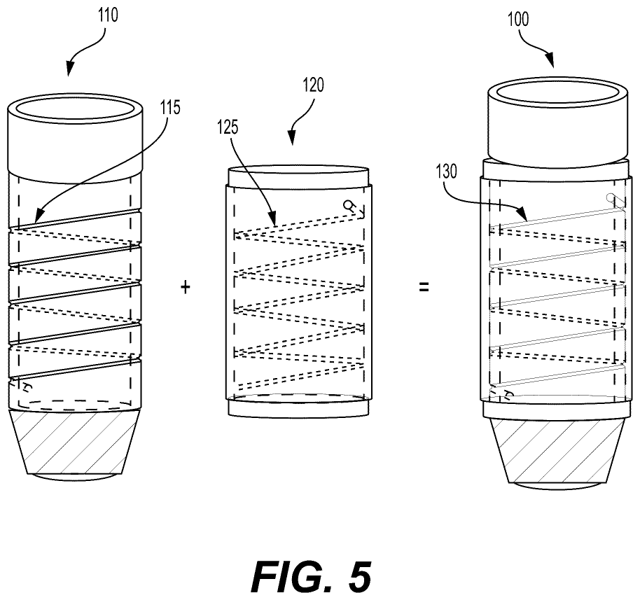

As illustrated in FIG. 5, the base magnetic tube 110 is fitted inside the external magnetic tube 120 and the pressure drop channel 130 receives a fluid at an inlet 131 with a first diameter and discharges said fluid at an outlet 132 with a second diameter. Furthermore, the pressure drop channel 130 is formed in a fitting region between the base magnetic tube 110 and the external magnetic tube 120.

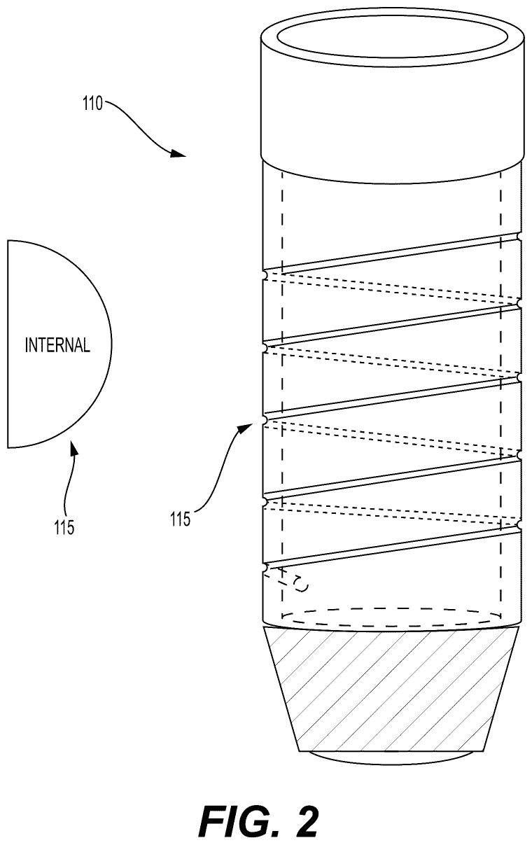

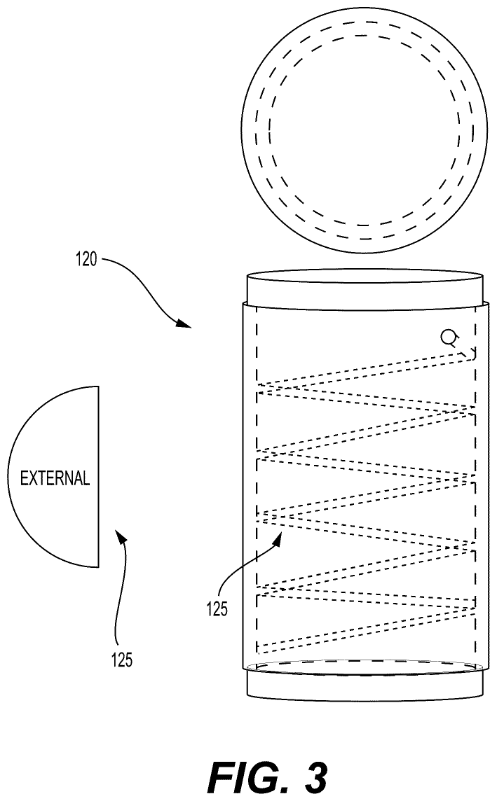

As illustrated in FIG. 2, the base magnetic tube 110 comprises a first half of the pressure drop channel 115 on an external surface thereof. As illustrated in FIG. 3, the external magnetic tube 120 comprises a second half of the pressure drop channel 125 on an internal surface thereof.

The base magnetic tube 110 and the external magnetic tube 120 may be manufactured from metal alloys permeable to a magnetic field containing a defined percentage of at least one element capable of generating a magnetic field. In some embodiments, the metal alloys permeable to magnetic fields may be inconel. Furthermore, the element capable of generating a magnetic field is preferably any one of neodymium, iron, boron, or a combination thereof.

In order to obtain a better effectiveness of the present application in inhibiting scaling, it is preferable that the base magnetic tube 110 and the external magnetic tube 120 have different respective magnetic orientations. In some embodiments, preferably, the base magnetic tube 110 comprises a south magnetic orientation and, preferably, the external magnetic tube 120 comprises a north magnetic orientation.

By using the aforementioned materials and with the preferred arrangement above, the aim is to obtain a vector product of magnetic field (B) by velocity (V) in the pressure drop channel 13) of at least 10,000 Ga·m/s in order to ensure effectiveness in generating mobile crystals that do not adhere to the internal walls of the pressure drop channel 130.

Furthermore, it should be noted that the fraction of these elements will be linked to the requirements of each project in order to achieve a specified vector product BXV. Thus, and as an example, sections that will process higher flows may receive a smaller quantity of the elements mentioned in the composition of the metal alloy.

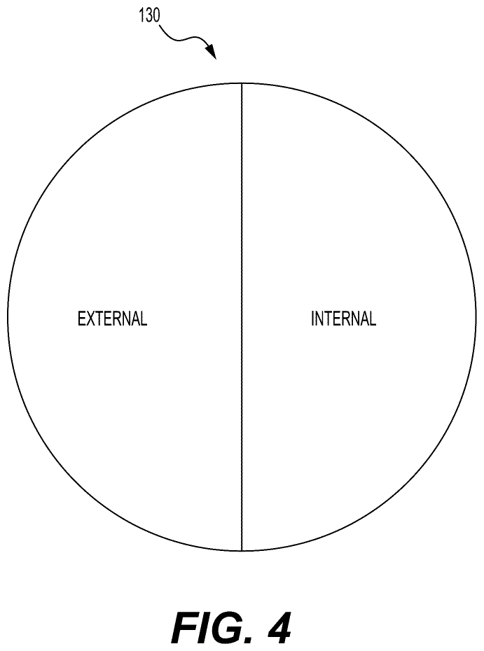

As illustrated in FIG. 4, the first 115 and second 125 halves of the pressure drop channel have a semicircular geometric shape and, when joined, form the pressure drop channel 130, which has a circular geometric shape.

The circular geometric shape of the pressure drop channel 130 is particularly advantageous because it provides a laminar flow along the inside of the pressure drop channel 130. It is known by a person skilled in the art that one of the critical factors in the occurrence of scale (precipitation of salts in the equipment) is the occurrence of a turbulent flow regime. Therefore, having a pressure drop generating channel with a circular geometric shape formed inside magnetic jackets has two advantages, the control of the flow regime and the inhibition of the critical path for the occurrence of precipitation by the magnetic field.

Furthermore, as illustrated in FIGS. 1 to 3, the pressure drop channel 130 has a preferably spiral arrangement. Furthermore, it is preferable that the first diameter 131 be larger than the second diameter 132, with a gradual taper between the first diameter 131 and the second diameter 132. The gradual taper assists in creating the pressure drop of the magnetic device 100.

In a preferred configuration of the magnetic device of the present application, the pressure drop channel 130 has a spacing between spirals of 100 mm. Furthermore, the first diameter 131 is preferably 6.35 mm (¼″) and the second diameter 132 is preferably 3.18 mm (⅛″). Furthermore, the base magnetic tube 110 is preferably at least 1 meter long and has an external diameter of 139.70 mm (5½″) and the external magnetic tube 120 is at least 0.70 m long and has an external diameter of 168.28 mm (6⅝″).

Notwithstanding the preferred dimensions above, it will be appreciated by a person skilled in the art that the specific dimensioning of the components needs to be done taking into account the particularities of each project, including characteristics of the fluids, the reservoir and the well.

Those skilled in the art will appreciate the knowledge being shown and will be able to reproduce the invention in the indicated embodiments and in other variants, covered by the scope of the attached claims.

1. A magnetic device for controlling fluid flow, the device comprising:
a base magnetic tube;
an external magnetic tube; and
a pressure drop channel for receiving a fluid via an inlet comprising a first diameter and discharging the fluid via an outlet comprising a second diameter,
wherein the base magnetic tube is fitted inside the external magnetic tube; and
wherein the pressure drop channel is formed in a fitting region between the base magnetic tube and the external magnetic tube.

2. The magnetic device of claim 1, wherein the base magnetic tube comprises a first half of the pressure drop channel on an external surface and the external magnetic tube comprises a second half of the pressure drop channel on an internal surface.

3. The magnetic device of claim 2, wherein the first half and the second half of the pressure drop channel have a semicircular geometric shape.

4. The magnetic device of claim 1, wherein the pressure drop channel has a circular geometric shape.

5. The magnetic device of claim 1, wherein the pressure drop channel has a spiral arrangement.

6. The magnetic device of claim 5, wherein the pressure drop channel comprises a spacing between spirals of 100 mm.

7. The magnetic device of claim 1, wherein the first diameter is larger than the second diameter, wherein there is a gradual taper between the first diameter and the second diameter.

8. The magnetic device of claim 7, wherein the first diameter is 6.35 mm (¼″) and the second diameter is 3.18 mm (⅛″).

9. The magnetic device of claim 1, wherein the base magnetic tube has an outer diameter of 139.70 mm (5½″) and the outer magnetic tube has an outer diameter of 168.28 mm (6⅝″).

10. The magnetic device of claim 1, wherein the base magnetic tube and the external magnetic tube are manufactured from metal alloys permeable to a magnetic field and contain a predefined percentage of at least one element capable of generating a magnetic field.

11. The magnetic device of claim 10, wherein the permeable metal alloys are inconel.

12. The magnetic device of claim 10, wherein the at least one element capable of generating a magnetic field is one or more of neodymium, iron, boron, or a combination thereof.

13. The magnetic device of claim 1, wherein the base magnetic tube and the external magnetic tube have different respective magnetic orientations.

14. The magnetic device of claim 1, wherein the base magnetic tube comprises a south magnetic orientation and the external magnetic tube comprises a north magnetic orientation.

15. The magnetic device of claim 1, wherein a vector product of a magnetic field (B) by a velocity (V) of the pressure drop channel reaches a value of 10,000 Ga·m/s.
